(19) United States
(12) Patent Application Publication
(10) Pub. No.: US 2011/0144993 A1
(43) Pub. Date: Jun. 16, 2011

(54) Disfluent-utterance tracking system and method

(75) Inventor: David Ruby, Paris (FR)

(73) Assignee: Disfluency Group, LLC

(21) Appl. No.: 12/653,616

(22) Filed: Dec. 15, 2009

(51) Int. Cl. G10L 15/06; G10L 15/04; G06T 11/20; H04M 1/65

(52) U.S. Cl. 704/243; 704/251; 345/440; 379/88.11; 704/E15.007; 704/E15.005

(57) ABSTRACT

A disfluent-utterance tracking system includes a speech transducer; one or more targeted-disfluent-utterance records stored in a memory; a real-time speech recording mechanism operatively connected with the speech transducer for recording a real-time utterance; and an analyzer operatively coupled with the targeted-disfluent-utterance record and with the real-time speech recording mechanism, the analyzer configured to compare one or more real-time snippets of the recorded speech with the targeted-disfluent-utterance record to determine and indicate to a user a level of correlation therebetween.

### FIELD OF THE INVENTION

The invention relates generally to the field of speech monitoring. More particularly, it concerns the problems of disfluent utterances.

Disfluent utterances are broadly defined herein to include the more conventional idle gap-filling utterances such as “hmm” or “uhm” to more recent extraneous utterances such as the gratuitously interjected “like”, “ya know”, “anyway”, “totally”, etc. Indeed, disfluent utterances run the gamut of idle gap-filling utterances that include the above; pauses, “ahems” (throat clears); idle repetition of silences, words, phrases; and or other unproductive (unintelligible or, worse, misleading) speech-like noises, and/or even the use of non-words such as “irregardless.” All such disfluent utterances impair the fidelity and efficiency of human communication, and give often inaccurate and always mixed signals about the utterer's intent, intelligence, comfort level with the speech topic, or, simply, fluency. Listeners tend to “tune out” a speaker during such disfluent utterances for obvious reasons, despite the potential importance of what the speaker has to say.

### BRIEF DESCRIPTION OF THE DRAWINGS

FIG. 1 is a detailed schematic diagram of the system in accordance with one embodiment of the invention.

FIG. 2 is a block diagram of the system in accordance with another embodiment of the invention.

FIGS. 3A and 3B are graphs illustrating disfluent-utterance tracking in the form of plural-disfluent-utterance histogram, with FIG. 3A showing a time-based histogram for a single utterance and that utterances rate/frequency and with FIG. 3B showing a “top-ten” or hit list of target utterances and their relative rates or frequencies.

FIG. 4 is a simplified flowchart of the invented disfluent-utterance tracking method.

### DETAILED DESCRIPTION OF THE PREFERRED EMBODIMENTS

It is desired to provide an automatic “listener” apparatus or system that 1) includes a memory for recording undesirable or otherwise targeted (“templated”) utterance that are potentially disfluent; 2) can be easily switched on and off during an individual's real-time speech; 3) records segments of such speech; 4) analyzes such recorded segments against such recorded templates; and 5) provides feedback to a speaker regarding the frequency of matches between the recorded, targeted utterance and actual, real-time utterances. Such feedback preferably takes the form of a report that optionally can be displayed on a portable hand-held device, preferably the same portable hand-held device into which the speaker has spoken, e.g. a mobile phone. These and other objects of the invention will become apparent upon a reading of this specification and claims in their entirety.

The present invention broadly targets a speaker's vocal utterances of any sort by pre-recording (defining the targeted (“templated”) utterance or utterances—words, phrases, pauses or even throat-clears would be broadly included and the utterance could of course be in any cognizable language); detects matches thereto contained in real-time speech by suitable speech-recognition and best-fit algorithms; and thereafter or in real time captures, analyzes, records and reports frequency and or rate or other relevant data representative of the correlation between the targeted utterance or utterances and the real-time speech.

Such data analysis might include a simple count or rate, e.g. five “like” utterances per minute, averages over time, trend lines, etc. Such data recording might include plural speech sessions over a defined time window, e.g. days or weeks. Such data reporting might include binary (good/bad or green light/red light) indicia, raw match counts, graphs such as histograms illustrating one or more targeted utterance frequencies or hits, long-term trend lines illustrating any increase or decrease over time of the frequency of such matches, etc.

The invented system, apparatus, and method can take any suitable form. For example, it can take the form of software or firmware executing on a processor within a workstation, personal computer (PC), personal digital assistant (PDA), or other hand-held portable device such as a mobile phone. It can be used in any suitable context whether personal or group. It can be used in any setting whether a toastmaster's club, on the street, in an office, in a game arcade, in a classroom or living room, or at a public gathering. The software can be embedded within an operating system, e.g. BiOS, Leopard, Linux, etc. or within another application, e.g. the voice recognition software of a mobile phone. The software can be stand-alone, dedicated (installed and executed on the user device) or can utilize a Software-as-a-Service (SaaS) (e.g. with a client application executing on the user device and with a server application executing on the so-called ‘back-end’ server or the like).

Indeed, the invention contemplates both models, as well as hybrids thereof.

A first “locked” or one-off (specific-utterance-dedicated and targeted) device would be provided for use by consumers wherein the targeted utterance is ‘hard-wired’ into the device's memory. Such a device could be stand-alone, or a remote server could be used to record or validate the user's input sound thereby to establish a template via a speech-to-text engine that generates a binary utterance for the purpose of comparing the utterance thereto. A second more universal, professional or co-called “Pro” model would be provided to monitor multiple utterances and users and would operate in conjunction with a central server in an SaaS on-line model.

The first, lower cost and simpler device might, for example, be marketed as a LIKE-O-METER™ product that is hard-wired or fixedly programmed to detect, count, and report occurrences of the disfluent use of “like.” LIKE-O-METER™ is a registration-pending trademark owned by the assignee of the present patent application, namely The Disfluency Group, LLC. World-wide rights are reserved. Those of skill in the art will appreciate that other targeted disfluencies would be hard-wired to detect, count, and report occurrences of other disfluent uses of, for example, “ya know”, “anyway”, “totally”, etc. The given disfluency application would be invoked by the user simply clicking on or off a single text key or title of the application, without further user input or selection required.

The second, higher cost and more complex SaaS device would target any one or more of plural disfluencies and might be used by linguists, speech therapists, clinicians, academics, etc. Data storage can be client and/or server based, and speech processing, tracking, and reporting would be done on the server and could be accessed by an application running on a PC or MAC™. Thus, with the Pro model, the user device is remotely connected online to a server for part or all of a monitoring session. And with the Pro model, the user typically would use the hand-held device to select targeted utterances and to monitor targeted, potentially disfluent speech.

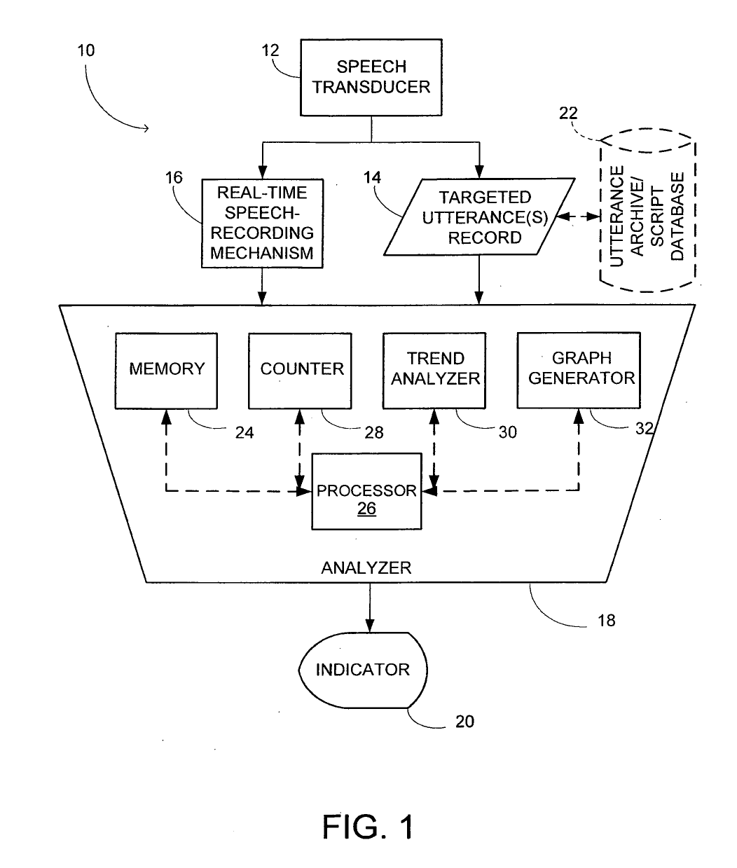

FIG. 1 illustrates the invented disfluent-utterance tracking apparatus 10 in accordance with one embodiment of the invention. System 10 may be seen to include a speech transducer (e.g. a microphone and associated circuitry) 12; a targeted-utterance(s) record 14 containing one or more recorded utterances; a real-time speech-recording mechanism 16; an analyzer/comparator 18; and an indicator (e.g. a display) 20. Those of skill in the art will appreciate that speech transducer 12 is operatively coupled in accordance with one embodiment of the invention with both targeted utterance(s) record 14 and real-time speech-recording mechanism 16. Also in accordance with one embodiment of the invention, targeted utterance(s) record 14 and real-time speech-recording mechanism 16 are operatively coupled with analyzer/comparator 18. Also in accordance with one embodiment of the invention, targeted utterance(s) record 14 and real-time speech-recording mechanism 16 are operatively coupled with analyzer/comparator 18. Finally, those of skill will appreciate that, in accordance with one embodiment of the invention, analyzer 18 is operatively coupled with indicator 20.

In use, system 10 as described above functions as follows: a speaker speaks into transducer 12 first to create a targeted utterance(s) record 14 stored in a memory. Record 14 may contain one or more individually targeted disfluent utterances desired by the speaker to be monitored. Thereafter, one or more snippets of the speaker's real-time speech is recorded in a memory. Next, analyzer/comparator 18 compares the one or more recorded real-time speech snippets with the one or more targeted and recorded disfluent utterances to determine a level of correlation, e.g. equivalency or substantial identity, therebetween. Finally, indicator 20 provides speech-fluency-performance feedback to the speaker. For example, indicator 20 indicates to the speaker the number or rate of instances within the speech snippets of disfluent utterances, or otherwise indicates historical data, trends, etc. in some useful form.

Those of skill in the art will appreciate that any suitable voice recognition software can be used by analyzer/comparator 18 to determine the level of correlation, i.e. to identify matches, between recorded targeted utterance records and speech snippets, whether the latter are analyzed in real time or based upon stored representations of such speech snippets. For example, voice recognition software that utilizes best-fit or other matching algorithms or artificial intelligence (AI) regimens can be used to advantage in implementing this part of the invented system and method. Many such voice recognition software applications provide for so-called “training” of the recognition software to an individual speaker's own individual and perhaps idiosyncratic frequencies, speech accents, patterns, inflections, pronunciations, pitch, pace, and other speech variables such that reliable matching is possible. Such a training mode whereby a speaker first pronounces a few key words and/or phrases to train the voice recognition software to the speaker's own voice parameters are contemplated as being within the spirit and scope of the invention.

FIG. 1 illustrates an optional feature of system 10 that involves centralized and typically remote archival recording in an utterance archive/script or database 22 of disfluent utterances. This can be provided to supplement or substitute for local record creation using speech transducer 12. Archive/script database 22 is operatively coupled with targeted utterance(s) record 14 and supplies selected ones of centrally maintained and data-based disfluent utterances in what might be thought of as a disfluent-speech repository. It can be generic or individual to a particular speaker, depending upon the sophistication of analyzer/comparator 18 in determining levels of correlation between real-time speech snippets and targeted utterance(s) records. Alternatively, a central database such as archive/script database 22 can more simply script a targeted utterance(s) recording session for the speaker, whereby the speaker is prompted to pronounce each scripted utterance for recording in targeted utterance(s) record 14. Third parties might maintain and update such an archive/script database 22 with the latest trends in disfluent speech.

Those of skill in the art will appreciate that analyzer/comparator 18 in accordance with one embodiment of the invention includes a memory 24 and a processor 26, and, optionally, a discrete counter 26, a discrete trend analyzer 28, and a discrete graph generator 30, some or all being operatively coupled together as illustrated. Programmed, special-purpose processor 32 executes instructions stored in memory 24—with or without assistance from a separate counter 26, trend analyzer 28, or a graph generator 30—to perform the analysis/comparison described herein between a real-time or recorded snippet of speech from recording mechanism 16 and a targeted utterance(s) record 14. Those of skill in the art will appreciate that the counter, trend analyzer, and graph generator functions can be integrally performed by the special-purpose computer processor executing instructions stored in memory, the processor and instructions executed thereby forming a machine that, along with the other components of the invention, are specially configured to perform the invented operations. Alternatively, these functions can be performed in hardware, firmware, or a combination of software, firmware and hardware, whereby hardware might be used to accelerate the analyzer to superior real-time performance.

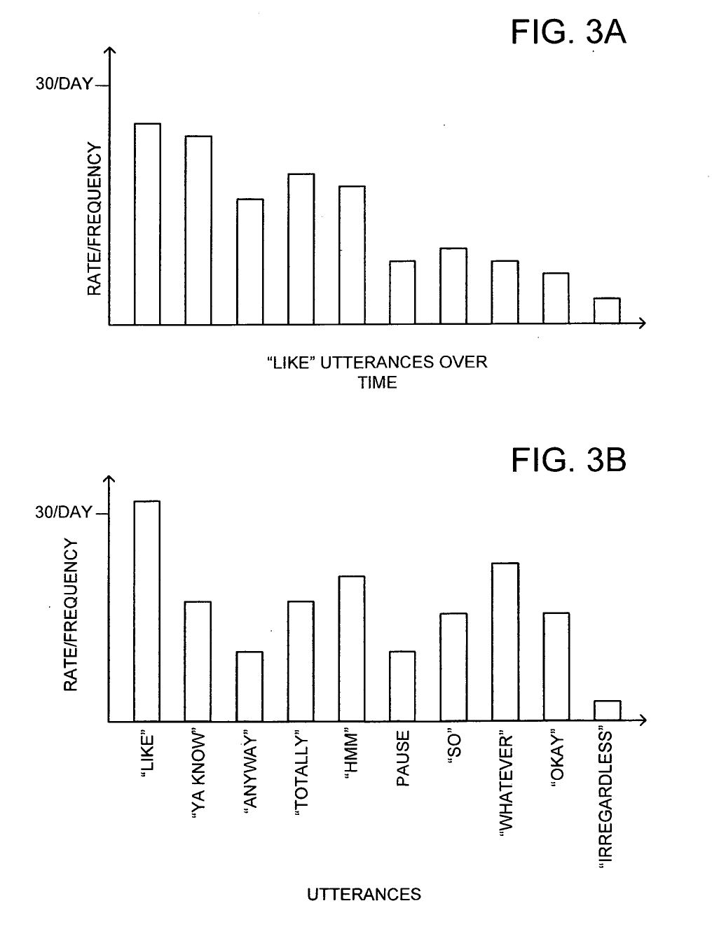

Those of skill in the art will appreciate that indicator/display 20 can be as simple as a light-emitting diode (LED) that emits green in response to a (desirable) low level of correlation and that emits red in response to an (undesirable) high level of correlation. Thus, the simplest go/no-go indicator 20 can be used to supply constructive feedback to the speaker in a simple and inexpensive visual form. More preferably, indicator 20 is a modestly competent display such as a liquid crystal display (LCD) on which a graph, e.g. a histogram, is displayed. In accordance with the invention, the graph can simply show a raw count indicating the number of instances of one or more targeted utterance(s) detected in the recorded speech. Or it can be a bar graph illustrating the number of instances and/or a rate of occurrence of such a match for one or more targeted utterances. Or it can be a histogram showing a historical time line of matches that conveys a trend line-type of analysis as constructive feedback to the speaker. These alternative indicator forms will be further illustrated below by reference to FIGS. 3A and 3B. Audible and/or tactile alternatives to visual indicators are also contemplated as being within the spirit and scope of the invention, as discussed below.

The software- (or perhaps firmware- or even hardware-) based solution will be understood to find broad utility on a fixed or mobile hardware platform whether installed workstation or PC or MAC™ or other platform as in a speech therapy clinic or TOASTMASTER™ venue or whether installed on a mobile digital device such as a mobile phone (e.g. PRE™, BLACKBERRY™, IPHONE™, DROID™, or the like) or PDA or dedicated pocketable device or accessory. Those of skill in the art will appreciate that the device may be smart or dumb, as the application could be installed and resident in the device's memory or could be provided on-line in accordance a Software-as-a-Service (SaaS) model. It could be turned on and off by a simple click of a button during a conversation, and could be represented as an icon on a computer “desktop.” It could be used in connection with on-line webinars, broadcast speeches, or even private gatherings (dialogues), public gatherings (classrooms, assemblies, parties, etc.) or office conferences. It might even find its way into gaming and entertainment venues whether public or in-home, off-line or on-line.

Indeed, a semi-private game context provides an entertaining way for a group of people to improve their individual and/or group fluency. For example, four “players” can use the device to baseline test and monitor their fluencies relative to one another, and can have fun doing so. Bets can be placed on which player might be the worst offender, e.g. the most disfluent player who most frequently misuses “like” or another targeted utterance. Conversely, prizes or rewards can be given to the most fluent player who least frequently misuses the targeted utterance. This will become clearer below when the ability of the invented system to distinguish various users by voice “signature analysis” or co-called ‘voice-printing’ or a like technique is explained. Those of skill will appreciate that game-playing is a well-respected technique for learning and improving skills because of its positive reinforcement nature.

Thus, those of skill in the art will appreciate that the invention can take various forms and can be used in various situations and venues to improve speech by providing real-time speech monitoring and either real-time or delayed feedback to the speaker in the form of an audible, tactile, or visual cue (e.g. a simple table, a written report, a graphic display, etc.) that captures the essence of whether a speaker over time is meeting or exceeding his or her desired fluent-speech-improvement goals.

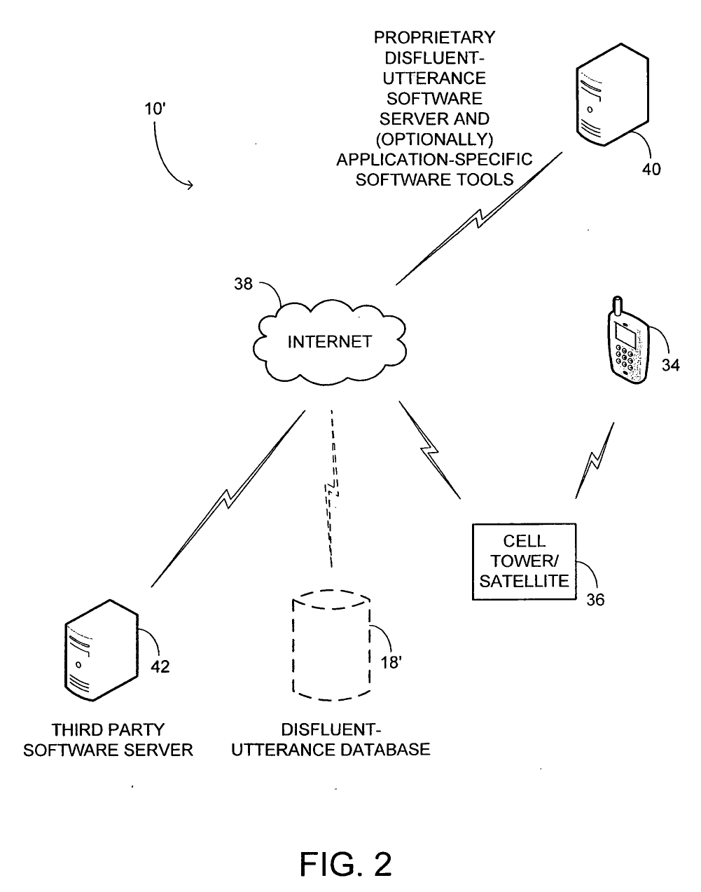

FIG. 2 illustrates invented system 10′ in an alternative, broader web-based form to better explicate the broad implications of the invention. System 10′ includes a handset such as a mobile telephone 34 that can be configured to run the application software described herein on a stand-alone basis connected, as is usual, to a telephone service provider's or carrier's cell tower and/or satellite 36. Alternatively, handset 34 can be configured to run the application software described herein on a SaaS basis over the Internet 38 utilizing remote software residing in a proprietary server 40 or a third-party server 42, as is known. System 10′ can also within the spirit and scope of the invention include a disfluent utterance database 18′ that is web-based, as shown. This last will be understood to be analogous to utterance archive/script database 22 shown in FIG. 1.

Alternative system configurations are also possible, and are contemplated as being within the spirit and scope of the invention. For example, system 10 shown in FIG. 1 (whether portable or not, whether web-based, Wi-Fi or Bluetooth-based, or standalone) can be installed in a public arena, a school classroom, a TOASTMASTERS™ club, etc. It can ‘listen’ to speech from any source, e.g. a podium-based microphone, a loudspeaker, a public address (PA) system, a radio or television broadcast, a sound booth in a speech-therapy clinic, etc. All such fixed or portable installations and contexts are contemplated as being within the spirit and scope of the invention.

FIGS. 3A and 3B illustrate in graph form two of many possible forms of a disfluent-utterance-tracking report or display in the form of a histogram. More particularly, FIGS. 3A and 3B are graphs illustrating graphic reports of disfluent-utterance tracking in the form of plural-disfluent-utterance histogram, with FIG. 3A showing a time-based histogram for a single utterance and that utterance's rate/frequency (the time base being arbitrary or being calibrated in hours, days, weeks, etc. as appropriate) and with FIG. 3B showing exemplary “top-ten” target utterances and their relative rates or frequencies over time. Those of skill in the art will appreciate that both are histograms, since they are graphs of historic data relating to disfluent-utterance(s). Those of skill in the art will appreciate that, in accordance with one embodiment of the invention, the speech-recognition software is designed to be somewhat tolerant such that its flags as favorable comparisons among or between phonetic equivalents, for example, among “ya know”, “y′know”, and “you know” or between “hmm” and “uhm.”

Either form or alternative forms may be useful and can be displayed on a display screen, for example, of indicator 20 of FIG. 1. Those of skill in the art will appreciate that FIG. 3A perhaps better illustrates a trend line analysis for a single utterance, whereas FIG. 3B perhaps better illustrates the relative disfluency of the speaker as among that user's targeted utterances. Yet both provide rate/frequency information to the user in simple, readable form.

Those of skill in the art will appreciate that alternative display/report forms are contemplated as being within the spirit and scope of the invention. For example, such graphs are not limited to bar graphs. For example, line graphs may be used instead of bar graphs. Moreover, raw data and/or counts of occurrences can be presented in any suitable, e.g. tabulated, form. Or the bars of the graph in FIG. 3B could be ordered from left to right in descending order of monitored rate or frequency, instead of the illustrated order (which might have been random or could have represented the order the speaker thought to represent the importance of the targeted disfluencies or might have represented the order in which the targeted disfluencies were entered by the speaker.) Or, as indicated above, a simple figure of merit or other success/failure indicator such as a green/red light may be used instead of using graphic or rate/frequency data.

Those of skill in the art will appreciate that alternatives to visual feedback are contemplated. For example, audible feedback such as a beep (e.g. a “gong”) or vibratory feedback such as a buzz can be used to indicate on the hand-held device that a targeted utterance has been detected. Such then provides real-time feedback to the user of the device that a disfluent utterance has occurred. These and other suitable alternative reporting and/or feedback mechanisms are contemplated as being within the spirit and scope of the invention.

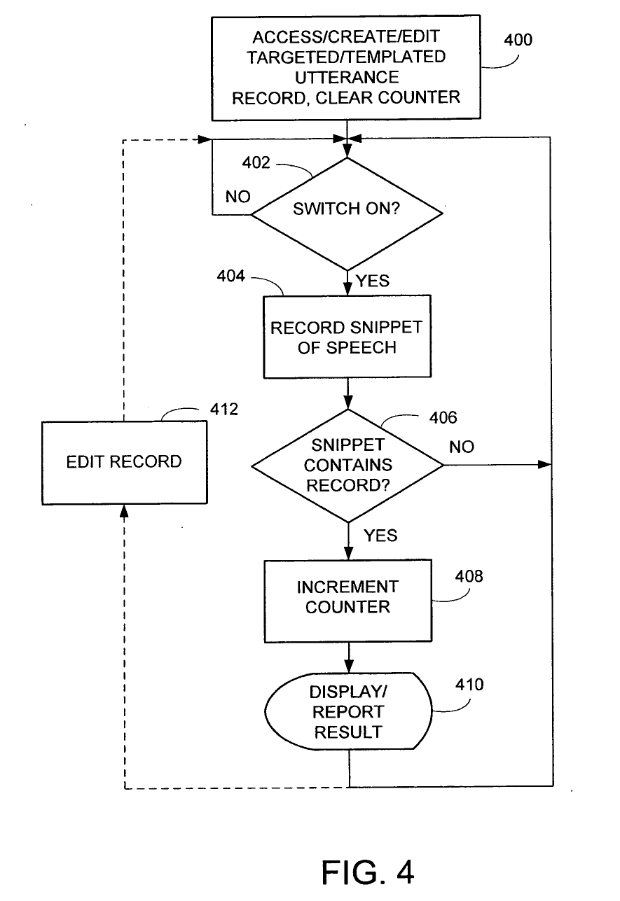

FIG. 4 is a simplified flowchart illustrating the invented method in accordance with one embodiment of the invention. At block 400, a targeted/templated utterance record is accessed, created, or edited; and a counter is initialized, i.e. cleared. At block 402, it is determined whether a switch is on or off. If the switch is off, then the switch is retested repeatedly until it is turned on. If the switch is on, then a snippet of speech is recorded at block 404. At block 406, it is determined whether the snippet of speech contains the targeted/templated utterance record. If not, the switch is tested again at block 402. If the snippet of speech contains the targeted/templated utterance record, i.e. if the speech snippet contains a disfluent utterance as defined by the speaker or a third party, then at block 408 the counter is incremented. At 410, the result of the speech snippet analysis/comparison is displayed/reported. Optionally, the targeted/templated utterance record is edited at block 412 to modify the one or more targeted-disfluent-utterances that are of interest to the speaker, in accordance with the more versatile Pro model described herein.

Block 400 in FIG. 4 includes the term ACCESS to illustrate the fact that, in the LIKE-O-METER™ model, a single (programmed, locked, fixed, permanent) disfluent utterance such as “like” is templated and targeted as being of singular concern. Thus, in accordance with this aspect of the invention, a single targeted utterance is stored or otherwise fixed or hard-wired and embedded within the hand-held device that is branded or advertised for the specific purpose of monitoring one or more user's speech for such a single targeted utterance, whether the single targeted utterance is “like”, “ya know”, “anyway”, “totally”, or some other. In such single-instance devices, the targeted utterance can be coded as text in ASCII, for example, and stored in a read-only-memory (ROM), a programmable logic array (PLA), a programmable ROM (PROM), an erasable PROM (EPROM), a fusible-link array, a mini- or micro-dipswitch, or any other suitably fixed and manufacturer- or distributor-pre-set form.

Those of skill in the art will appreciate that determining step 406 can utilize any suitable existing voice-print technology such as that used in security access systems including, for example, Biometric Security's VOICE VAULT™ or Porticus Technology, Inc.'s VERSONA™, I2R′s speaker recognition technology, or the like. It is believed that such voice-print identification and discrimination among multiple user vocalizations relies on unique anatomical-and-resulting-speech relationships that affect vocal frequency content including harmonics that are in large part determined by an utterer's anatomical idiosyncrasies such as sinus cavity, oral cavity, and skull dimensions and densities, and other natural (e.g. anatomical) or learned attributes (e.g. affectations). Nevertheless, applicant does not intend to be limited in the scope of the present invention to any particular theory of operation or to any particular voice-print or other utterance identification approach. Suffice it to say that high-security access control appears to be migrating from fingerprint and retinal/corneal scans to voice-printing as the preferred personal identification standard in the most sensitive security contexts.

Those of skill in the art will appreciate that voice recognition in the area of disfluent-utterance tracking systems and methods can be somewhat less robust than those used in the area of access security and yet can remain useful and accurate. Thus, it is believed that the voice-print and allied arts are more than adequate to teach the individual-speaker discrimination and identification requirements of the plural-speaker embodiments wherein each speaker's utterance is analyzed for disfluent-utterance content and an associated one of plural counters is incremented and optionally feedback obtained in one form or another.

In accordance with one embodiment of the invention described above, of course, individual speaker identification and plural speaker discrimination is not required. Instead, it may be assumed that there is a single speaker, and all speech within a chosen snippet thereof is analyzed and a single count reported indicative of the number of instances of positive correlation between a record or target disfluent utterance and any spoken utterance.

Such spoken and optionally recorded utterances for comparison purposes with the disfluent-utterance record of one or more targeted utterances can be very simply converted from speech to text and stored in a digital memory as a binary code, e.g. ASCII could be used to represent the spoken utterances in memory. Thereafter, the recorded code string representing the speech-to-text conversion can be compared using a sliding window of variable widths to determine any matches to the one or more disfluent-utterances record. Any binary coding of the spoken-utterance text string is contemplated as being within the spirit and scope of the invention. Those of skill in the art will appreciate that all that is needed is the ability to compare sub-snippets of a memory-based digital representation of the spoken utterance string with a memory-based digital representation of the targeted disfluent utterance and to accurately identify matches or near matches. This is the case whether single-targeted utterances such as in the LIKE-O-METER™ product or plural-targeted utterances such as in the Pro model are of interest.

Those of skill in the art will appreciate that a handset, e.g. a mobile telephone or PDA, in accordance with one embodiment of the invention can include a housing that contains a hard switch, e.g. a dedicated or programmable finger-or-thumb-actuable physical switch, or a soft switch, e.g. a touch- or proximity-activated switch or icon appearing on a touch-sensitive display screen. Such a switch can be used to turn the disfluent-utterance tracking system and method application software alternately on and off. Those of skill in the art will also appreciate that the on-off switch can be a soft switch that is voice actuated, as many modern mobile phones and other digital handheld devices include the ability to respond to simple voice commands and to auto-dial telephone number prompts by pronounced callee name. Indeed, the embedded voice-recognition and user-voice-training software that is found in many portable phones can also readily perform the needed voice training and recognition functions of the invented system and method. Those of skill in the art will appreciate that some mobile phones have relatively closed voice-recognition software architectures (e.g. IPHONE™) while others are relatively open (e.g. DROID™), the latter making the use of such platforms more straightforward.

(This increasingly ubiquitous voice recognition capability is also widely used in remote server applications such as telephonic digital directory assistance and auto-answer menu selection, as well as in keyless computer text-entry, e.g. word-processing, systems.)

Those of skill in the art also will appreciate that an individual or individuals using the invented system and method can choose their favorite colors, icons, avatars, etc. to indicate the count or other raw or processed data, e.g. graphs, representing their speech fluency on a display or other report. The users may be prompted, e.g. by a script located either on a hand-held device or at a remote server, to voice one or more specific words or utterances for tracking purposes. The speech-to-text conversion can be performed locally, e.g. in the handheld device or other local platform, or it can be performed remotely, e.g. on a web-based server remote from the handheld device or other local platform. The spoken word or phrase can be validated via a look-up table to ensure that the word compares favorably to the licensed version of the application. As each user speaks the word or phrase and the comparison checks out, then that user is given an affirmative indication and the next user is promoted to his or her validation and setup opportunity.

Semantic or normative processing involving certain linguistic assumptions then is used to quantitatively and/or qualitatively evaluate each user's speech during a given session. Normative frequency data can accompany the raw count to assist each user in evaluating his or her speech. For example, if a speaker says “like” more than twice in twenty seconds, the speaker will be warned that at least some uses of the “like” utterance were disfluent. Thus, normal or normative speech and behavioral data can be used to assist the evaluation of whether a particular use of the targeted utterance is truly (probably) disfluent or is an acceptable occurrence. Alternative modalities of evaluating snippets of speech for disfluencies are contemplated as being within the spirit and scope of the invention.

Without prejudice or limitation, then, and in accordance with one embodiment of the invention, the software/hardware architecture is as generic as possible to encompass multiple single, locked versions, limited to a specific utterance, as well as a Pro version for use by speech therapists or other persons of interest. For the sake of simplicity, the first part of the description immediately below covers the first locked version, i.e. the LIKE-O-METER™ product.

After launching the application, a brief introduction is displayed of the application's purpose, as well as a brief tutorial. This embodiment of the invention supports from one to four users who are prompted individually to enter their names, to chose their colors, and to enter their verbal utterances of the word “like”. Successive users repeat the utterance in their own idiosyncratic voices, up to a maximum n users (n being any integer value indicating that, within the spirit and scope of the invention, any number n of users or “players” are accommodated). Each utterance template is translated from speech into text and compared with the “version key” of the individual application to validate the users. An incorrect match prompts the user to voice the word again, and when all utterances are validated, they are stored either on the device or on a server.

The Pro model embodiment of the application bypasses the validation step, thus allowing for an unlimited number of individual possible uses for the application. Additionally, each “player” selects his or her feedback method, e.g. vibrating, flashing the screen, issuing a sound on the device, presenting a visual report in the form of counters or graphics, or the like. The application compares up to n voices in real time (‘on the fly’) to the stored templates, incrementing a separate counter on each detection. If desired, the application issues a visual indication, e.g. presenting an icon or illuminating or flashing the display screen; or issues an audio indication, e.g. a sound such as a beep; or invokes a tactile indication, e.g. a vibration, upon each occurrence of any one of the targeted utterances. The Pro application saves the results on the server, which can be accessed by the user via an application on a hand-held device, a PC, a MAC™, or the like that might be equipped with enhanced analytical tools and historical records.

Those of skill in the art will appreciate that the software that implements the specific algorithms discussed herein, as well as the data or records, that are stored in memory can reside in a charge-coupled device (CCD), a read-only memory (ROM), a Flash Drive or so-called memory stick (e.g. compatible or not with a universal serial bus (USB) port), etc. or any other suitable data storage device. Alternatively, an analog recording device could be used, which would require an analog-to-digital converter (ADC) to produce a digital utterance code for comparison purposes. The memory containing the snippet(s) can utilize a limited, e.g. looping, (sliding-window) memory and/or comparator to reduce storage requirements. The memory typically would contain multiple targeted utterances, except with the LIKE-O-METER™ product described herein. Even in the locked single template version for multiple users, multiple targeted utterances are stored, since each person speaks the same word differently, so the binary code generated is different for each, thus the number of utterances is limited only to the depth of the memory and the power of the processor.

In accordance with another embodiment of the invention, efficiency can be monitored as a part of fluency, e.g. by indicating a percentage of dead time (PAUSE) in conversation. This is suggested by FIG. 3B, which uses a(n unspoken) PAUSE as one of the targeted “top ten” utterances.

Alternatively, the feedback could use neutral feedback: it could be judgment neutral, e.g. coherent/fluent words per minute (wpm) like with a typing tutor. Thus, the invention is not limited to any particular form, whether positive or negative, of feedback. Moreover, the feedback could be educational yet non-judgmental, and could be based upon the user's particular disfluency or disfluencies.

Alternatively, the processor could use positive feedback: it could calculate a figure of merit in terms of fluent-speech value index, thus delivering to the user of the device positive as opposed to negative feedback. Indeed, monetary or non-monetary rewards could be given to a user of the invented system and method showing the most fluency improvement over the least time.

The device alternatively or additionally could analyze third-party speech on a telephone (perhaps with permission as may be required in some jurisdictions). The device could include a script-driven recording session that (dis)favors common (dis)fluencies, with the setup script on a third-party server that the user clicks through during setup. The record itself can be stored in a remote database.

Those of skill in the art will appreciate that some disfluencies are clear while others are ambiguous. Thus, semantic processing plays a role in distinguishing truly disfluent utterances from perfectly acceptable utterances that are homonymous therewith. For example, “irregardless” has never been, is not now, and will never be a recognized English-language word. So its presence in a speech snippet should always be flagged (subject to semantic mis-interpretations wherein the spoken utterance actually was “ . . . ear. Regardless, . . . .” On the other hand, “like” finds a perfectly appropriate English-language use as a noun (“or the like”), a verb (“I like you”), a preposition (“someone like you”), an adjective (“of like mind”), a conjunction (“drove like crazy”), and perhaps other legitimate parts of speech. Thus, the speech recognition algorithm could utilize or could be assisted by suitable parsing means, e.g. artificial intelligence (AI) software, firmware or hardware, as is known, or alternative means, to identify phonemes and phoneme streams with a higher degree of accuracy and/or to do any required semantic speech processing.

Further, as described above, to avoid false-positive indications of disfluent utterances within speech snippets, the invention could use not only semantic processing but also statistical or normative speech processing that either performs the analyzing/comparing step with certain linguistic assumptions “in mind”, or reports along with the count to a speaker also a normative-frequency or use indication for human comparison purposes to reduce or altogether avoid false-positive indications of disfluencies where there are in fact none.

Alternative mechanisms for implementing the spirit and scope of the invented disfluent-utterance tracking invention, while not necessarily described or illustrated herein, nevertheless may fall within the spirit and scope of the invention as ultimately claimed. Thus, any and all suitable means of tracking and optionally reporting and displaying disfluent utterances are contemplated as being within the spirit and scope of the invention.

Those of skill in the art will appreciate that steps of the invented method can be re-ordered, and that blocks of the invented system can be omitted, augmented, rearranged, or differently partitioned (e.g. to combine one or more functions into one logical block or to separate one logical block into two or more separate functions). Such are contemplated as being within the spirit and scope of the invention broadly described and illustrated herein. Those of skill in the art also will appreciate that speech snippets and/or targeted disfluent-utterance(s) can be recorded in an analog format rather than being digitized and stored in a digital format, with the analyzer operating on analog speech rather than on digital speech, all within the spirit and scope of the invention.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides many advantages over conventional human-listener individual or group feedback that is uncommonly and inconsistently provided during normal human discourse. Those of skill in the art will appreciate that the ease of use, unassuming (non-threatening, discreet) ‘presence’, and real-time or delayed feedback via report or display, of the speech monitoring provides privacy to the speaker who is trying to improve his or her speech by using the invention described and illustrated herein. The near ubiquity of mobile phones makes such private use of and speech-pattern improvement by a user of the invention available to an increasing and far-reaching population of speakers in an increasingly fluent, global society.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

Finally, those of skill in the art will appreciate that the invented method, system and apparatus described and illustrated herein may be implemented in software, firmware or hardware or any suitable combination thereof. Preferably, the method, system and apparatus are implemented in a combination of the three, for purposes of low cost and flexibility. Thus, those of skill in the art will appreciate that the method, system and apparatus of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A disfluent-utterance tracking system comprising:
a speech transducer;
one or more targeted-disfluent-utterance records stored in a memory;
a real-time speech recording mechanism operatively connected with the speech transducer for recording a real-time utterance; and
an analyzer operatively coupled with the targeted-disfluent-utterance record and with the real-time speech recording mechanism, the analyzer configured to compare one or more real-time snippets of the recorded speech with the targeted-disfluent-utterance record to determine a level of correlation therebetween.

2. The system of claim 1 further including
a display configured to represent the determined level of correlation.

3. The system of claim 1, wherein the analyzer includes a counter configured to count the number of occurrences of a match between a targeted-disfluent-utterance record and the one or more real-time snippets, and wherein the determined level of correlation represents the number of occurrences.

4. The system of claim 1, wherein the analyzer includes a counter configured to count the number of occurrences of a match between a targeted-disfluent-utterance record and the one or more real-time snippets over time, and wherein the determined level of correlation represents a rate or number of occurrences per unit time.

5. The system of claim 1, wherein the speech recording mechanism is configured to record plural real-time snippets of the recorded speech.

6. The system of claim 1, wherein the real-time recorded utterance also is stored in a digital memory.

7. The system of claim 1, wherein the analyzer includes a voice-recognition mechanism including an individual voice recognition training mechanism.

8. The system of claim 1, wherein the record contains plural instances of targeted-disfluent-utterances, and wherein the analyzer is configured to compare one or more real-time snippets with each of the plural targeted-disfluent-utterances to determine plural levels of correlation there between.

9. The system of claim 1 further comprising:
an on-off switch for selectively operating the recording mechanism.

10. The system of claim 9, wherein the speech transducer and the on-off switch are contained within a singular housing.

11. The system of claim 10, wherein the housing further contains a telephone.

12. The system of claim 1, wherein the one or more records is permanently stored in the memory during a system configuration process performed by a manufacturer or distributor of the system.

13. The system of claim 1, wherein the one or more records is created by a user during initial system setup and is temporarily stored in the memory for indefinite use thereafter.

14. The system of claim 1, wherein at least the speech transducer and the analyzer are embedded in a hand-held device that forms a part of the system.

15. The system of claim 1, wherein at least the speech transducer is embedded in a hand-held device that forms a part of the system, and wherein at least one of the one or more records and the analyzer is stored and executed in a web-based server that forms a part of the system and that is remotely connectable to the hand-held device.

16. A method for tracking targeted-disfluent-utterances contained in a speaker's speech, the method comprising:
(a) creating a record of one or more targeted-disfluent-utterances;
(b) recording a snippet of speech in real time; and
(c) comparing the record with the snippet to detect one or more instances of the one or more targeted-disfluent-utterances therein.

17. The method of claim 16 further comprising:
(d) counting the number of instances.

18. The method of claim 17 further comprising:
(e) indicating the counted number to the speaker.

19. The method of claim 18, wherein the indicating includes displaying a representation of the counted number.

20. The method of claim 18, wherein the displaying includes displaying of the representation of a raw count.

21. The method of claim 18, wherein the displaying includes displaying of the representation of a graph.

22. The method of claim 21, wherein the displaying includes displaying of the representation of a graph that includes a histogram.

23. The method of claim 18, wherein the displaying of the representation is to the speaker on a display coupled with a handset.

24. The method of claim 23, wherein the displaying of the representation on the handset is on a telephone on which the speaker speaks.

25. The method of claim 24, wherein the steps (a), (b), and (c) are performed by a software application executing in a process within the telephone.

26. The method of claim 23, wherein at least one of the steps (a), (b), and (c) is performed on a web-based server remote from but operatively connectable to the telephone.

27. The method of claim 23 further comprising:
providing an on-and-off switch for starting-and-stopping the recording.

28. The method of claim 23, wherein the providing of the on-and-off switch includes providing a soft switch associated with the handset's display.

29. The method of claim 27, wherein the providing of the on-and-off switch includes providing a soft switch that is voice actuated.

30. The method of claim 18, wherein the creating is of a singular record of only one targeted-disfluent utterance, and wherein the single-utterance record is permanently stored in a handheld device.

31. The method of claim 18, wherein the creating is of a plural record of two or more targeted-disfluent utterances, and wherein the plural-utterance record is temporarily stored in one of a handheld device and a web-based server remote therefrom.

32. The method of claim 18 further comprising:
(f) editing the record to modify the one or more targeted-disfluent-utterances.

33. The method of claim 32 further comprising:
repeating the steps (b), (c), and (d).

34. The method of claim 18 which further comprises:
(e) distinguishing among speech patterns of individual ones of plural speakers and separately counting the number of instances for each of one or more snippets of speech from each of the plural corresponding speakers.
